(19) United States
(12) Patent Application Publication
(10) Pub. No.: US 2025/0018796 A1
(43) Pub. Date: Jan. 16, 2025

(54) INSTRUMENT PANEL SUPPORT STRUCTURE

(71) Applicant: TOYOTA JIDOSHA KABUSHIKI KAISHA, Toyota-shi (JP)

(72) Inventor: Takashi NAGAO, Miyoshi-shi (JP)

(73) Assignee: TOYOTA JIDOSHA KABUSHIKI KAISHA, Toyota-shi (JP)

(21) Appl. No.: 18/741,783

(22) Filed: Jun. 13, 2024

(30) Foreign Application Priority Data
Jul. 11, 2023 (JP) 2023-113576

(51) Int. Cl. B60K 37/10

(52) U.S. Cl. CPC B60K 37/10

(57) ABSTRACT

The instrument panel support structure supports the instrument panel on the vehicle body via the support member, and includes a panel displacement allowing mechanism that allows displacement of the instrument panel with deformation of the support member in response to an impact applied to the instrument panel. The deformation of the support member causes resistance, and the instrument panel is displaced while being subjected to the resistance, whereby the impact energy is absorbed.

### CROSS-REFERENCE TO RELATED APPLICATION

This application claims priority to Japanese Patent Application No. 2023-113576 filed on Jul. 11, 2023, incorporated herein by reference in its entirety.

### BACKGROUND

### 1. Technical Field

The present disclosure relates to an instrument panel support structure that supports an instrument panel provided in a vehicle cabin on a vehicle body.

### 2. Description of Related Art

When a collision of a vehicle against an object existing ahead of the vehicle is referred to as a “front collision” of the vehicle, a secondary collision in which an occupant or the like in the vehicle cabin collides against an instrument panel provided in the vehicle cabin may be caused in the front collision. A surface material of the instrument panel may be damaged in the secondary collision. In order to suppress damage to the surface material, for example, Japanese Unexamined Patent Application Publication No. 2020-177146 (JP 2020-177146 A) discloses a technique in which a member surrounding the surface material is formed so as to project from the surface material so that the occupant or the like collides against the member surrounding the surface material prior to a collision against the surface material during a secondary collision.

### SUMMARY

The technique described in JP 2020-177146 A relates to an instrument panel support structure including a unit that suppresses damage to a surface material of an instrument panel. However, there is still a great deal of room for improvement or new development of the unit, and the improvement and new development of the unit can achieve a more practical instrument panel support structure. The present disclosure has been made in view of such circumstances, and addresses an issue of providing an instrument panel support structure with high practicality.

In order to address the above issue, an aspect of the present disclosure provides an instrument panel support structure that supports an instrument panel provided in a vehicle cabin on a vehicle body, in which the instrument panel is supported on the vehicle body via a support member; and the instrument panel support structure includes a panel displacement allowing mechanism that allows displacement of the instrument panel with deformation of the support member when an impact is applied to the instrument panel.

The “panel displacement allowing mechanism” according to the present disclosure can also be considered as an “impact absorbing mechanism” that absorbs an impact applied to the instrument panel. Specifically, the deformation of the support member causes resistance, and impact energy is absorbed when the instrument panel is displaced while being subjected to the resistance. In the technique according to the related-art document described above, an impact is absorbed by deforming the member surrounding the surface material without displacing the instrument panel, and the instrument panel support structure according to the present disclosure is significantly different from the support structure according to the related-art document in that the instrument panel itself is displaced. With the instrument panel support structure according to the present disclosure, damage to the surface material of the instrument panel in a secondary collision is effectively suppressed by the panel displacement allowing mechanism.

The “instrument panel” according to the present disclosure is to be interpreted in a narrow sense, and means a portion of a component existing under a windshield in the vehicle cabin, in which instruments, a display, and the like are disposed and which faces an occupant. Correspondingly, the term “dashboard” as used herein means a portion of the component existing above the instrument panel and extending generally in the front-rear direction and the right-left direction. When a member that forms the surface of the instrument panel is referred to as a “surface material”, the surface material is generally formed from a material that is relatively easily damaged when an impact is applied, such as glass or a transparent hard resin, for example.

On the other hand, in general, an instrument panel reinforcement is disposed on the vehicle front side of the instrument panel and on the lower side of the dashboard so as to extend in the right-rear direction of the vehicle. The instrument panel reinforcement is a reinforcing member that forms a part of the vehicle body, and is a pipe-shaped member, for example.

The “support member” according to the present disclosure allows the instrument panel to be supported on the vehicle body and, in other words, connects the instrument panel and the vehicle body. Thus, the dashboard also functions as the support member. In addition, a bracket may be provided on the instrument panel reinforcement, and the bracket may support the instrument panel. In that case, the bracket functions as the support member. The dashboard may also be supported on the instrument panel reinforcement.

The support member is deformed by the impact, and deformation of the support member may be elastic deformation or plastic deformation. When the deformation is plastic deformation, an elastic force generated in the support member can be suppressed to effectively absorb an impact. When the impact is applied, plastic deformation of the support member may progress, and the support member may be broken.

When deformation of the support member is described more specifically, the support member may be provided with a weak portion, that is, a weakened portion, by reducing the wall thickness, forming a notch, or the like, for example, and the support member may be deformed at the weakened portion when the impact is applied to the instrument panel. Specifically, the support member may be broken, bent, or curved at the weakened portion. That is, the panel displacement allowing mechanism may be constituted by the weakened portion.

In many cases, a “car navigation device” is disposed on the instrument panel, and the car navigation device (hereinafter occasionally abbreviated as “car navigation”) generally includes a “main body portion” disposed inside the instrument panel and a “display” integrated with the main body portion. Regarding such car navigation, the surface material of the display functions as the surface material of the instrument panel.

When the instrument panel is configured to include the car navigation, the instrument panel support structure according to the present disclosure may be specifically configured such that the main body portion is supported on an instrument panel reinforcement via a bracket as the support member, and the display is supported on the vehicle body via a dashboard as another support member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an instrument panel support structure of an embodiment;

FIG. 2 is a diagram illustrating an instant at which an object collides with an instrument panel in the instrument panel support structure of the embodiment;

FIG. 3A illustrates a modification of the brackets, dashboards, which are support members in the exemplary instrument panel support structure;

FIG. 3B illustrates a modification of the brackets, dashboards, which are support members in the exemplary instrument panel support structure;

FIG. 3C is for illustrating a variation of the dashboard, brackets, which are support members in the example instrument panel support structure; and

FIG. 4 is a diagram for explaining shock absorption in the instrument panel support structure of the embodiment.

### DETAILED DESCRIPTION OF EMBODIMENTS

Hereinafter, an instrument panel support structure according to an embodiment of the present disclosure will be described in detail with reference to the drawings as an embodiment for carrying out the present disclosure. In addition to the embodiments described below, the present disclosure can be implemented in various embodiments in which various modifications and improvements are made based on the knowledge of a person skilled in the art, including the embodiments described in SUMMARY.

### EXAMPLES

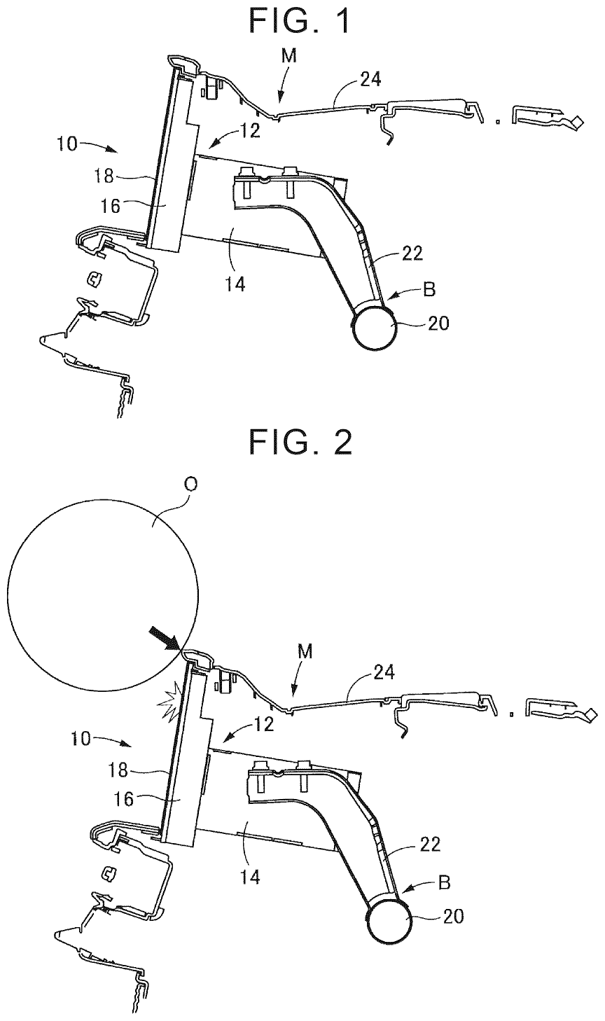

FIG. 1 is a view of a part of the vehicle cut along a plane extending in the up-down direction and the back-up direction, and the instrument panel support structure of the embodiment is a structure for supporting the instrument panel 10 on a vehicle body (not shown). In the drawing, a car navigation device 12 (hereinafter, sometimes abbreviated as “car navigation 12”) is shown as a part of the instrument panel 10, and the car navigation 12 includes a main body portion 14 and a display 16 integrally provided on the main body portion 14. The portion 18 constituting the surface of the display 16 functions as a surface material of the instrument panel 10. Hereinafter, the portion 18 is referred to as a surface material 18, and the surface material 18 is made of transparent glass.

The vehicle is provided with an instrument panel reinforcement 20 (hereinafter, sometimes simply referred to as “reinforcement 20”) as a part of the vehicle body. The reinforcement 20 has a pipe shape having a circular cross section, and is disposed across the left and right sides of the vehicle.

The car navigation 12, which is a part of the instrument panel 10, is supported by a vehicle body by two types of support members. Specifically, the main body portion 14 is supported by the reinforcement 20, which is a part of the vehicle body, via a pair of left and right brackets 22, each of which is one type of support member, and the display 16 is supported by the vehicle body via a dashboard 24, which functions as another type of support member, on the upper portion. Incidentally, although not shown in the 15 drawings, the dashboard 24 itself is supported by the reinforcement 20.

When the vehicle on which the instrument panel 10 is disposed collides with, for example, an obstacle or the like in front of the vehicle, as shown in FIG. 2, an object O such as an occupant may collide secondarily with the instrument panel 10. FIG. 2 shows a state in which the object O is secondarily collided with a part where the car navigation 12 is disposed, but at this time, the bracket 22 and the dashboard 24, which are support members, are firm, and when the car navigation 12 is firmly supported by the vehicle body, it is predicted that the impact caused by the secondary collision acts violently on the display 16 and the surface material 18 is damaged. To be easy to understand, there is a possibility that the glass as the surface material 18 may crack.

Therefore, in the instrument panel support structure of the present embodiment, a panel displacement allowing mechanism is provided to allow displacement of the instrument panel 10 accompanied by deformation of the bracket 22 and the dashboard 24, which are support members, respectively, in response to an impact applied to the instrument panel 10, and more specifically, displacement of the car navigation 12. The panel displacement allowing mechanism will be described in detail below.

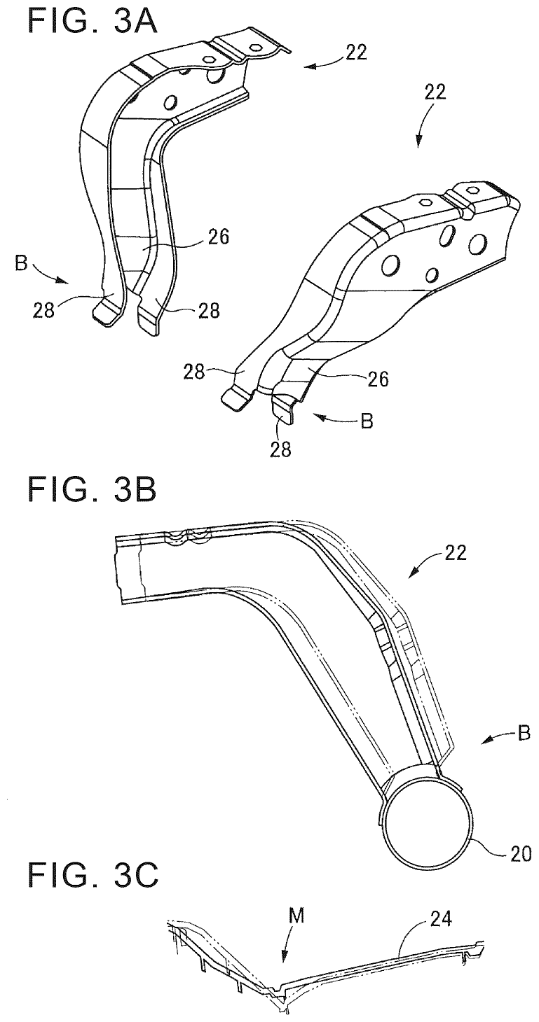

Each of the pair of brackets 22 is generally channel-shaped, as shown in FIG. 3A. Each of the brackets 22 is welded to the reinforcement 20 at the base end portion B. In particular, at the base end portion B there is no web 26 in the form of a channel, but only a pair of flanges 28 facing each other in parallel. Each of the flanges 28 is relatively thin.

Therefore, when a certain amount of force is applied to the distal end portion of the brackets 22 in a direction generally toward the front side of the vehicle, the flanges 28 are bent in the thickness direction as indicated by a two-dot chain line in FIG. 3B. In other words, each bracket 22 is plastically deformed so as to buckle at the base end portion B. That is, the base end portion B functions as a weak body portion in the support member.

On the other hand, as shown in FIG. 1, the dashboard 24 is bent to a certain extent at an intermediate portion M in the front-rear direction of the vehicle. Then, when a certain amount of force is applied to the vehicle-rear-side part in a direction generally toward the vehicle-front side, the dashboard 24 is plastically deformed so as to increase the bending in the intermediate portion M, as indicated by a two-dot chain line in FIG. 3C. Briefly, the intermediate portion M has a shape that is easily bent when a certain amount of force is applied, and the intermediate portion M also functions as a weak body portion in the support member.

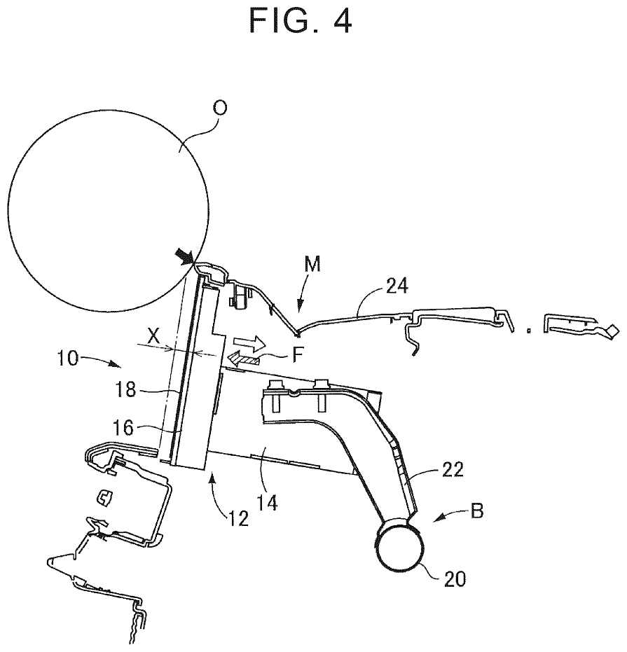

When an impact is applied to the instrument panel 10 supported by the vehicle body via the support member having the weak portion as described above, the instrument panel 10 is displaced toward the front of the vehicle as shown in FIG. 4. Specifically, the bracket 22 for supporting the main body portion 14 of the car navigation 12 and the dashboard 24 for supporting the display 16 are plastically deformed as described above, so that the car navigation 12 constituting the instrument panel 10 itself is displaced toward the vehicle front side. More specifically, the two-dot chain line in the figure indicates the position of the instrument panel 10 at the moment when the object O collides, and thereafter, the instrument panel 10 is displaced in the direction indicated by the open arrow with the deformation of the bracket 22 and the dashboard 24.

That is, the instrument panel support structure includes a mechanism constituted by the intermediate portion M of the base end portion B, dashboard 24 of the bracket 22 as a weak portion of the support member. That is, the instrument panel support structure includes a panel displacement allowing mechanism that allows displacement of the instrument panel 10 accompanied by deformation of the support member in response to an impact applied to the instrument panel 10.

In the plastic deformation of the bracket 22 and the dashboard 24, deformation resistance is generated. This deformation resistance acts on the instrument panel 10 in a direction opposite to the direction of displacement, that is, in the direction of the shaded arrow shown in the drawing. In other words, the displacement of the instrument panel 10 against the deformation resistance is allowed. When the displacement of F, instrument panel 10 is x, the shock absorbing energy E, which is the shock energy absorbed by the displacement, is generally expressed by the following equation.

E=F·x

Such an impact absorbing effect is exerted, and thus, in the present instrument panel support structure, damage to the surface material 18 of the instrument panel 10 is effectively prevented. In view of this, the above-described panel displacement allowing mechanism can also be referred to as a shock absorbing mechanism.

What is claimed is:

1. An instrument panel support structure that supports an instrument panel provided in a vehicle cabin on a vehicle body, wherein:
the instrument panel is supported on the vehicle body via a support member; and
the instrument panel support structure includes a panel displacement allowing mechanism that allows displacement of the instrument panel with deformation of the support member when an impact is applied to the instrument panel.

2. The instrument panel support structure according to claim 1, wherein deformation of the support member in the panel displacement allowing mechanism is plastic deformation.

3. The instrument panel support structure according to claim 1, wherein the support member is provided with a weakened portion, and the support member is deformed at the weakened portion when the impact is applied.

4. The instrument panel support structure according to claim 1, wherein:
the instrument panel is configured to include a car navigation device that includes a main body portion and a display; and
the main body portion is supported on an instrument panel reinforcement as a part of a vehicle body via a bracket as the support member, and the display is supported on the vehicle body via a dashboard as another support member.
